(19) United States
(12) Patent Application Publication
(10) Pub. No.: US 2024/0394893 A1
(43) Pub. Date: Nov. 28, 2024

(54) SEGMENTATION WITH MONOCULAR DEPTH ESTIMATION

(71) Applicant: QUALCOMM Incorporated, San Diego, CA (US)

(72) Inventors: Yingyong QI, San Diego, CA (US); Xin LI, San Diego, CA (US); Xiaowen YING, San Diego, CA (US); Shuai ZHANG, San Diego, CA (US)

(21) Appl. No.: 18/695,794

(22) PCT Filed: Dec. 1, 2021
(86) PCT No.: PCT/CN2021/134849

§ 371 Date: Mar. 26, 2024

(51) Int. Cl. G06T 7/194; G06V 10/25; G06V 10/75

(52) U.S. Cl. CPC G06T 7/194; G06V 10/25; G06V 10/751; G06T 2207/10028

(57) ABSTRACT

Systems, methods, and computer-readable media are provided for performing image segmentation with depth filtering. In some examples, a method can include obtaining a frame capturing a scene: generating, based on the frame, a first segmentation map including a target segmentation mask identifying a target of interest and one or more background masks identifying one or more background regions of the frame; and generating a second segmentation map including the first segmentation map with the one or more background masks filtered out, the one or more background masks being filtered from the first segmentation map based on a depth map associated with the frame.

### CROSS-REFERENCE TO RELATED APPLICATIONS

This application for Patent is a 371 of international Patent Application PCT/CN2021/134849, filed Dec. 1, 2021, which is hereby incorporated by referenced in its entirety and for all purposes.

### TECHNICAL FIELD

The present disclosure generally relates to image processing. For example, aspects of the present disclosure relate to segmentation with monocular depth estimation.

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

Many image processing techniques implemented rely on image segmentation algorithms that divide an image into segments which can be analyzed or processed to identify objects, produce specific image effects, etc. Some example practical applications of image segmentation include, without limitation, chroma key compositing, feature extraction, object detection, recognition tasks (e.g., object recognition, face recognition, etc.), image stylization, machine vision, medical imaging, and depth-of-field (or “bokeh”) effects, among others. However, camera devices and image segmentation techniques often yield poor and inconsistent results.

### BRIEF SUMMARY

Systems and techniques are described herein for improving the stability of segmentation with monocular depth estimation. According to at least one example, a method is provided for segmentation with monocular depth estimation. An example method can include obtaining a frame capturing a scene: generating, based on the frame, a first segmentation map including a target segmentation mask identifying a target of interest and one or more background masks identifying one or more background regions of the frame; and generating a second segmentation map including the first segmentation map with the one or more background masks filtered out, the one or more background masks being filtered from the first segmentation map based on a depth map associated with the frame.

According to at least one example, a non-transitory computer-readable medium is provided for segmentation with monocular depth estimation. An example non-transitory computer-readable medium can include instructions that, when executed by one or more processors, cause the one or more processors to: obtain a frame capturing a scene: generate, based on the frame, a first segmentation map including a target segmentation mask identifying a target of interest and one or more background masks identifying one or more background regions of the frame; and generate a second segmentation map including the first segmentation map with the one or more background masks filtered out, the one or more background masks being filtered from the first segmentation map based on a depth map associated with the frame.

According to at least one example, an apparatus is provided for segmentation with monocular depth estimation. An example apparatus can include memory and one or more processors coupled to the memory, the one or more processors being configured to: obtain a frame capturing a scene: generate, based on the frame, a first segmentation map including a target segmentation mask identifying a target of interest and one or more background masks identifying one or more background regions of the frame; and generate a second segmentation map including the first segmentation map with the one or more background masks filtered out, the one or more background masks being filtered from the first segmentation map based on a depth map associated with the frame.

According to at least one example, another apparatus is provided for segmentation with monocular depth estimation. The apparatus can include means for obtaining a frame capturing a scene: generating, based on the frame, a first segmentation map including a target segmentation mask identifying a target of interest and one or more background masks identifying one or more background regions of the frame; and generating a second segmentation map including the first segmentation map with the one or more background masks filtered out, the one or more background masks being filtered from the first segmentation map based on a depth map associated with the frame.

In some aspects, the method, non-transitory computer-readable medium, and apparatuses described above can include generating the depth map using a neural network.

In some examples, generating the second segmentation map can include: based on a comparison of the first segmentation map with the depth map, determining a threshold difference between respective depth values associated with the one or more background masks and respective depth values associated with the target segmentation mask identifying the target of interest. In some examples, the second segmentation map further includes, based on the threshold difference between respective depth values associated with the one or more background masks and respective depth values associated with the target segmentation mask identifying the target of interest, removing the one or more background masks from the first segmentation map.

In some examples, the depth map can include a set of depth masks associated with depth values corresponding to pixels of the frame. In some aspects, generating the second segmentation map can include: based on a comparison of the first segmentation map with the depth map, determining an overlap between the target segmentation mask identifying the target of interest and one or more depth masks from the set of depth masks in the depth map: based on the overlap, keeping the target segmentation mask identifying the target of interest; and based on an additional overlap between the one or more background masks and one or more additional depth masks from the set of depth masks, filtering the one or more background masks from the first segmentation map.

In some aspects, generating the second segmentation map further includes: determining that a difference between depth values associated with the one or more additional depth masks and depth values associated with the one or more depth masks exceeds a threshold; and based on the difference exceeding the threshold, filtering the one or more background masks from the first segmentation map. In some examples, the one or more depth masks correspond to the target of interest and the one or more additional depth masks correspond to the one or more background regions of the frame.

In some aspects, generating the second segmentation map can include: determining intersection-over-union (IOU) scores associated with depth regions from the depth map and predicted masks from the first segmentation map: based on the IOU scores, matching the depth regions from the depth map with the predicted masks from the first segmentation map, the predicted masks can including the target segmentation mask identifying the target of interest and the one or more background masks identifying the one or more background regions of the frame; and filtering the one or more background masks from the first segmentation map based on a determination that one or more IOU scores associated with the one or more background masks are below a threshold.

In some aspects, the method, non-transitory computer-readable medium, and apparatuses described above can include prior to filtering the one or more background masks from the first segmentation map, applying adaptive Gaussian thresholding and noise reduction to the depth map.

In some examples, the frame can include a monocular frame generated by a monocular image capture device.

In some examples, the first segmentation map and the second segmentation map are generated using one or more neural networks.

In some aspects, the method, non-transitory computer-readable medium, and apparatuses described above can include generating, based on the frame and the second segmentation map, a modified frame. In some examples, the modified frame can include at least one of a visual effect, an extended reality effect, an image processing effect, a blurring effect, an image recognition effect, an object detection effect, a computer graphics effect, a chroma keying effect, and an image stylization effect.

In some aspects, each of the apparatuses described above is, can be part of, or can include a mobile, device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative examples of the present application are described in detail below with reference to the following drawing figures:

FIG. 1 is a block diagram illustrating an example image processing system, in accordance with some examples of the present disclosure;

FIG. 2 illustrates an example scene with numerous objects in the background, in accordance with some examples of the present disclosure:

FIG. 3 is a diagram illustrating an example process for segmentation with depth estimation, in accordance with some examples of the present disclosure, in accordance with some examples of the present disclosure:

FIG. 4 is a diagram illustrating an example depth filtering process for generating a segmentation output based on a segmentation map and estimated depth information, in accordance with some examples of the present disclosure:

FIG. 5 is a diagram illustrating an example training stage and an inference stage for segmentation with depth filtering, in accordance with some examples of the present disclosure:

FIG. 6 is a diagram illustrating examples of segmented frames without depth filtering and with depth filtering, in accordance with some examples of the present disclosure:

FIG. 7 is a flowchart of an example of a process for semantic segmentation with depth filtering, in accordance with some examples of the present disclosure:

FIG. 8 illustrates an example computing device architecture, in accordance with some examples of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

As previously noted, computing devices are increasingly being equipped with capabilities for capturing images, performing various image processing tasks, generating various image effects, etc. Many image processing tasks and effects, such as chroma keying, depth-of-field or “bokeh” effects, object detection, recognition tasks (e.g., object, face, and biometric recognition), feature extraction, background replacement, image stylization, automation, machine vision, computer graphics, medical imaging, etc., rely on image segmentation to divide an image into segments that can be analyzed or processed to perform the desired image processing tasks or generate the desired image effects. For example, cameras are often equipped with a portrait mode function that enables shallow depth-of-field (“bokeh”) effects. A depth-of-field effect can bring a specific image region or object into focus, such as a foreground object or region, while blurring other regions or pixels in the image, such as background regions or pixels. The depth-of-field effect can be created using image segmentation techniques to identify and modify different regions or objects in the image, such as background and foreground regions or objects.

In some cases, users may only be interested in certain foreground objects in an image and/or video. For example, users may only be interested in the foreground objects that are close to them, such as when a user takes a selfie of herself or a selfie of a small group of people. As another example, users may be interested in certain foreground targets in a video stream or a video recording, a personal media production, a presentation, etc. In some cases, a device can be configured to perform object-based processing where objects of interest are identified using semantic segmentation and optionally enhanced through post-processing.

Semantic segmentation can produce a pixel-by-class mapping of a view, where the objects within a class, such as person, are identified from the image data. In many cases, the accuracy of semantic segmentation can be reduced when there are persons or objects farther away (e.g., relative to a closer person or object of interest, such as a foreground target) in a captured scene. The reduced accuracy can be caused by the smaller size of the persons or objects that are farther away in the scene and/or their smaller resolution. The inaccuracies and/or inconsistencies of the semantic segmentation can cause artifacts and/or flickering in the video when remote persons and/or objects (e.g., persons and/or objects that are farther away in the captured scene and/or in the background) are included in the captured scene. Accurate semantic segmentation can detect and segment people and/or objects in the background that are not of interest and a target(s) of interest, such as a foreground object.

In the following disclosure, systems, apparatuses, methods (also referred to as processes), and computer-readable media (collectively referred to herein as “systems and techniques”) are described herein for improving the stability of segmentation using monocular depth estimation. In some examples, the systems and techniques described herein can generate a segmentation output, such as a segmentation map, that includes a target of interest and excludes any objects and/or people in the background that are not of interest. The systems and techniques described herein can generate a segmentation map and a depth map from an input frame, and use the estimated depth values in the depth map to filter items in the segmentation map that are beyond a threshold depth or range and/or are not connected to a segmentation target. The systems and techniques described herein can then generate a more accurate segmentation output. In some examples, the systems and techniques described herein can generate the segmentation map and the depth map from a monocular image. The systems and techniques described herein can use the depth map to filter out background items in the image and keep the segmentation target of interest in the segmentation output.

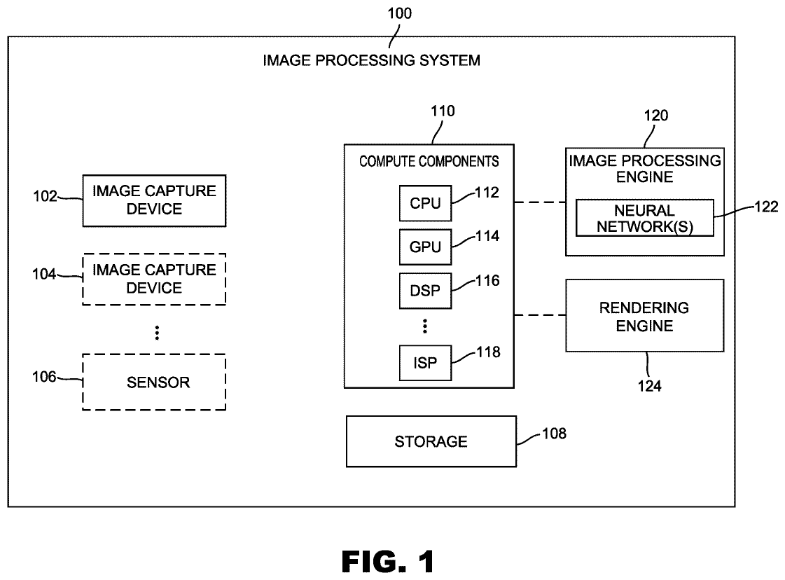

FIG. 1 is a diagram illustrating an example image processing system 100, in accordance with some examples. The image processing system 100 can perform the segmentation techniques described herein. Moreover, the image processing system 100 can perform various image processing tasks and generate various image processing effects as described herein. For example, the image processing system 100 can perform image segmentation, foreground prediction, background replacement, depth-of-field effects, chroma keying effects, feature extraction, object detection, image recognition, machine vision, and/or any other image processing and computer vision tasks.

In the example shown in FIG. 1, the image processing system 100 includes image capture device 102, storage 108, compute components 110, an image processing engine 120, one or more neural network(s) 122, and a rendering engine 124. The image processing system 100 can also optionally include one or more additional image capture devices 104: one or more sensors 106, such as light detection and ranging (LIDAR) sensor, a radio detection and ranging (RADAR) sensor, an accelerometer, a gyroscope, a light sensor, an inertial measurement unit (IMU), a proximity sensor, etc. In some cases, the image processing system 100 can include multiple image capture devices capable of capturing images with different FOVs. For example, in dual camera or image sensor applications, the image processing system 100 can include image capture devices with different types of lenses (e.g., wide angle, telephoto, standard, zoom, etc.) capable of capturing images with different FOVs (e.g., different angles of view, different depths of field, etc.).

The image processing system 100 can be part of a computing device or multiple computing devices. In some examples, the image processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, a laptop or notebook computer, a tablet computer, a set-top box, a television, a display device, a digital media player, a game console, a video streaming device, a drone, a computer in a car, an IoT (Internet-of-Things) device, a smart wearable device, an extended reality (XR) device (e.g., a head-mounted display, smart glasses, etc.), or any other suitable electronic device(s).

In some implementations, the image capture device 102, the image capture device 104, the other sensor(s) 106, the storage 108, the compute components 110, the image processing engine 120, the neural network(s) 122, and the rendering engine 124 can be part of the same computing device. For example, in some cases, the image capture device 102, the image capture device 104, the other sensor(s) 106, the storage 108, the compute components 110, the image processing engine 120, the neural network(s) 122, and the rendering engine 124 can be integrated into a smartphone, laptop, tablet computer, smart wearable device, game system, XR device, and/or any other computing device. However, in some implementations, the image capture device 102, the image capture device 104, the other sensor(s) 106, the storage 108, the compute components 110, the image processing engine 120, the neural network(s) 122, and/or the rendering engine 124 can be part of two or more separate computing devices.

In some examples, the image capture devices 102 and 104 can be any image and/or video capture devices, such as a digital camera, a video camera, a smartphone camera, a camera device on an electronic apparatus such as a television or computer, a camera system, etc. In some cases, the image capture devices 102 and 104 can be part of a camera or computing device such as a digital camera, a video camera, an IP camera, a smartphone, a smart television, a game system, etc. In some examples, the image capture devices 102 and 104 can be part of a dual-camera assembly. The image capture devices 102 and 104 can capture image and/or video content (e.g., raw image and/or video data), which can then be processed by the compute components 110, the image processing engine 120, the neural network(s) 122, and/or the rendering engine 124 as described herein.

In some cases, the image capture devices 102 and 104 can include image sensors and/or lenses for capturing image data (e.g., still pictures, video frames, etc.). The image capture devices 102 and 104 can capture image data with different or same FOVs, including different or same angles of view, different or same depths of field, different or same sizes, etc. For example, in some cases, the image capture devices 102 and 104 can include different image sensors having different FOVs. In other examples, the image capture devices 102 and 104 can include different types of lenses with different FOVs, such as wide angle lenses, telephoto lenses (e.g., short telephoto, medium telephoto, etc.), standard lenses, zoom lenses, etc. In some examples, the image capture device 102 can include one type of lens and the image capture device 104 can include a different type of lens. In some cases, the image capture devices 102 and 104 can be responsive to different types of light. For example, in some cases, the image capture device 102 can be responsive to visible light and the image capture device 104 can be responsive to infrared light.

The other sensor(s) 106 can be any sensor for detecting and measuring information such as distance, motion, position, depth, speed, etc. Non-limiting examples of sensors include LIDARs, ultrasonic sensors, gyroscopes, accelerometers, magnetometers, RADARs, IMUs, audio sensors, light sensors, etc. In one illustrative example, the sensor 106 can be a LIDAR configured to sense or measure distance and/or depth information which can be used when calculating depth-of-field and other effects. In some cases, the image processing system 100 can include other sensors, such as a machine vision sensor, a smart scene sensor, a speech recognition sensor, an impact sensor, a position sensor, a tilt sensor, a light sensor, etc.

The storage 108 can include any storage device(s) for storing data, such as image data for example. The storage 108 can store data from any of the components of the image processing system 100. For example, the storage 108 can store data or measurements from any of the image capture devices 102 and 104, the other sensor(s) 106, the compute components 110 (e.g., processing parameters, outputs, video, images, segmentation maps, depth maps, filtering results, calculation results, etc.), and/or any of the image processing engine 120, the neural network(s) 122, and/or the rendering engine 124 (e.g., output images, processing results, parameters, etc.). In some examples, the storage 108 can include a buffer for storing data (e.g., image data) for processing by the compute components 110.

In some implementations, the compute components 110 can include a central processing unit (CPU) 112, a graphics processing unit (GPU) 114, a digital signal processor (DSP) 116, and/or an image signal processor (ISP) 118. The compute components 110 can perform various operations such as image enhancement, feature extraction, object or image segmentation, depth estimation, computer vision, graphics rendering. XR (e.g., augmented reality, virtual reality, mixed reality, and the like), image/video processing, sensor processing, recognition (e.g., text recognition, object recognition, feature recognition, facial recognition, pattern recognition, scene recognition, etc.), foreground prediction, machine learning, filtering, depth-of-field effect calculations or renderings, tracking, localization, and/or any of the various operations described herein. In some examples, the compute components 110 can implement the image processing engine 120, the neural network(s) 122, and the rendering engine 124. In other examples, the compute components 110 can also implement one or more other processing engines.

The operations of the image processing engine 120, the neural network(s) 122, and the rendering engine 124 can be implemented by one or more of the compute components 110. In one illustrative example, the image processing engine 120 and the neural network(s) 122 (and associated operations) can be implemented by the CPU 112, the DSP 116, and/or the ISP 118, and the rendering engine 124 (and associated operations) can be implemented by the GPU 114. In some cases, the compute components 110 can include other electronic circuits or hardware, computer software, firmware, or any combination thereof, to perform any of the various operations described herein.

In some cases, the compute components 110 can receive data (e.g., image data, etc.) captured by the image capture device 102 and/or the image capture device 104, and process the data to generate output images or videos having certain visual and/or image processing effects such as, for example, depth-of-field effects, background replacement, tracking, object detection, etc. For example, the compute components 110 can receive image data (e.g., one or more still images or video frames, etc.) captured by the image capture devices 102 and 104, perform depth estimation, image segmentation, and depth filtering, and generate an output segmentation result as described herein. An image (or frame) can be a red-green-blue (RGB) image having red, green, and blue color components per pixel: a luma, chroma-red, chroma-blue (YCbCr) image having a luma component and two chroma (color) components (chroma-red and chroma-blue) per pixel: or any other suitable type of color or monochrome picture.

The compute components 110 can implement the image processing engine 120 and the neural network(s) 122 to perform various image processing operations and generate image effects. For example, the compute components 110 can implement the image processing engine 120 and the neural network(s) 122 to perform feature extraction, superpixel detection, foreground prediction, spatial mapping, saliency detection, segmentation, depth estimation, depth filtering, pixel classification, cropping, upsampling/downsampling, blurring, modeling, filtering, color correction, noise reduction, scaling, ranking, adaptive Gaussian thresholding and/or other image processing tasks. The compute components 110 can process image data captured by the image capture device 102 and/or 104: image data in storage 108: image data received from a remote source, such as a remote camera, a server or a content provider: image data obtained from a combination of sources: etc.

In some examples, the compute components 110 can generate a depth map from a monocular image captured by the image capture device 102, generate a segmentation map from the monocular image, generate a refined or updated segmentation map based on a depth filtering performed by comparing the depth map and the segmentation map to filter pixels/regions having at least a threshold depth, and generate a segmentation output. In some cases, the compute components 110 can use spatial information (e.g., a center prior map), probability maps, disparity information (e.g., a disparity map), image queries, saliency maps, etc., to segment objects and/or regions in one or more images and generate an output image with an image effect, such as a depth-of-field effect. In other cases, the compute components 110 can also use other information such as face detection information, sensor measurements (e.g., depth measurements), depth measurements, etc.

In some examples, the compute components 110 can perform segmentation (e.g., foreground-background segmentation, object segmentation, etc.) at (or nearly at) pixel-level or region-level accuracy. In some cases, the compute components 110 can perform segmentation using images with different FOVs. For example, the compute components 110 can perform segmentation using an image with a first FOV captured by image capture device 102, and an image with a second FOV captured by image capture device 104. The segmentation can also enable (or can be used in conjunction with) other image adjustments or image processing operations such as, for example and without limitation, depth-enhanced and object-aware auto exposure, auto white balance, auto-focus, tone mapping, etc.

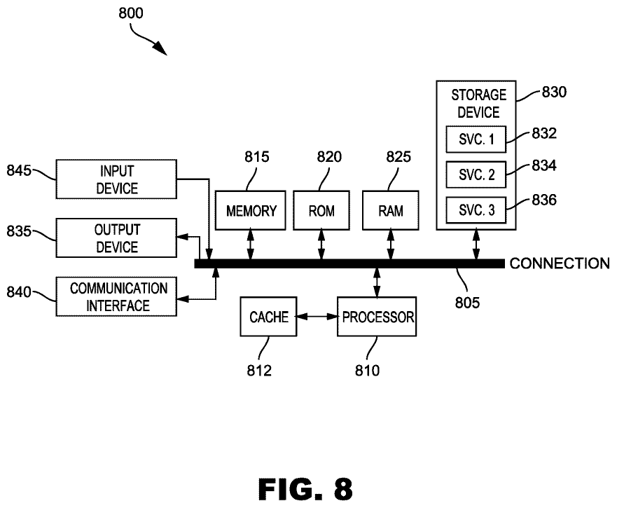

While the image processing system 100 is shown to include certain components, one of ordinary skill will appreciate that the image processing system 100 can include more or fewer components than those shown in FIG. 1. For example, the image processing system 100 can also include, in some instances, one or more memory devices (e.g., RAM, ROM, cache, and/or the like), one or more networking interfaces (e.g., wired and/or wireless communications interfaces and the like), one or more display devices, and/or other hardware or processing devices that are not shown in FIG. 1. An illustrative example of a computing device and hardware components that can be implemented with the image processing system 100 is described below with respect to FIG. 8.

In some cases, semantic segmentation can produce a pixel-by-class mapping of a view, where the objects within a class, such as person, are identified from the image data. As previously mentioned, in many cases, the accuracy of semantic segmentation can be reduced when there are persons or objects farther away (e.g., relative to a foreground or target of interest, such as a foreground person or object) in a captured scene. The reduced accuracy can be caused by the smaller size of the persons or objects that are farther away in the scene and/or their smaller resolution. The inaccuracies and/or inconsistencies of the semantic segmentation can cause artifacts and/or flickering in the video when remote persons and/or objects (e.g., persons and/or objects that are farther away in the captured scene and/or in the background) are included in the captured scene. Accurate semantic segmentation can detect and segment people and/or objects in the background that are not of interest and a target(s) of interest, such as a foreground object.

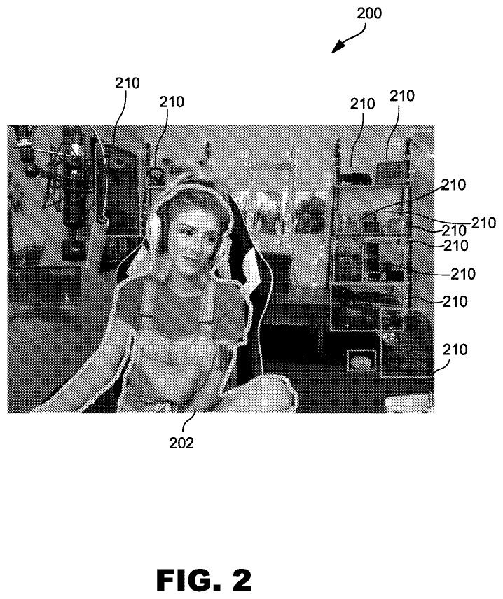

FIG. 2 illustrates an example scene 200 with numerous objects 210 in the background. In this example, the person 202 in the scene is the target of interest for semantic segmentation. The person 202 has been detected in the scene by the image processing system 100. However, the objects 210, which are not targets of interest for segmentation, have also been detected. As shown, the objects 210 are farther away from the person 202, are smaller than the person 202, and thus are more difficult to distinguish, filter, and/or determine that such objects are not of interest. This can result in segmentation inaccuracies/inconsistencies. Moreover, this can cause flickering in a video of the scene 200. For example, as the image processing system 100 performs semantic segmentation of frames capturing the scene 200, the objects 210 may be detected in some frames and not others. This can cause flickering between frames as the objects 210 are segmented in some frames and not others.

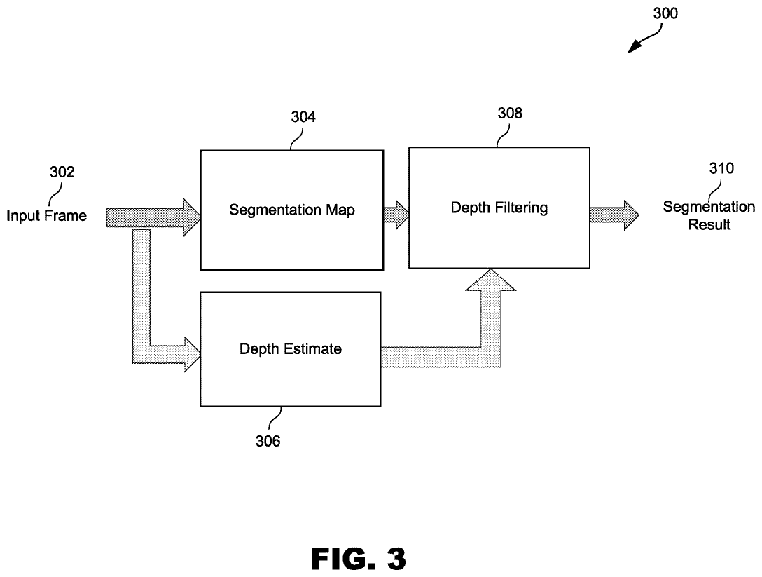

FIG. 3 is a diagram illustrating an example process 300 for segmentation with depth estimation, in accordance with some examples of the present disclosure. The process 300 can improve the stability of segmentation results using depth estimation in addition to the semantic segmentation. For example, the process 300 can reduce or avoid flickering as previously described, can yield more accurate segmentation results, etc. In some examples, the process 300 can use monocular depth estimation to filter out certain portions of the segmentation results. For example, the process 300 can use monocular depth estimation to filter out objects and/or people in a segmentation map that are farther away (e.g., have at least a threshold depth) from the target of interest (e.g., the foreground target, etc.), and generate a segmentation result with depth filtering.

As shown in FIG. 3, the process 300 generates (e.g., via the image processing system 100) a segmentation map 304 from an input frame 302. In some examples, the process 300 can perform semantic segmentation on the input frame 302 to generate the segmentation map 304. In addition, the process 300 generates depth estimates 306 from the input frame 302. In some examples, the depth estimates 306 can include a monocular depth estimate, and the input frame 302 can include a monocular camera image frame.

In some cases, the depth estimates 306 can include a depth map of the input frame 302. In some examples, the depth estimates 306 can estimate the depth of every pixel of the input frame 302. The process 300 can use the depth estimates 306 to perform depth filtering 308. For example, the depth estimates 306 can be used to filter out unwanted items (e.g., smaller/remote objects, etc.) in the background to minimize or prevent flickering. For example, the process 300 can compare the segmentation map 304 with the depth estimates 306. The process 300 can match salient depth regions from the depth estimates 306 with predicted masks in the segmentation map 304. The process 300 can keep any predicted masks in the segmentation map 304 that match and/or at least partially overlap with one or more salient depth regions from the depth estimates 306, and filter out any predicted masks in the segmentation map 304 that do not match and/or at least partially overlap with one or more salient depth regions from the depth estimates 306.

Based on the depth filtering 308, the process 300 can output a segmentation result 310. The segmentation result 310 can exclude or filter out any predicted masks in the segmentation map 304 that do not match and/or at least partially overlap with one or more salient depth regions from the depth estimates 306. Thus, in some examples, the segmentation result 310 can include a filtered segmentation map. For example, the segmentation result 310 can maintain any predicted masks in the segmentation map 304 that match and/or overlap with one or more salient depth regions from the depth estimates 306. In some examples, the items removed/filtered from the segmentation map 304 can include items (e.g., objects, people, regions, etc.) that have a larger depth value in the depth map (e.g., the depth estimates 306) than one or more items in the depth map corresponding to one or more segmentation masks or items in the segmentation map 304.

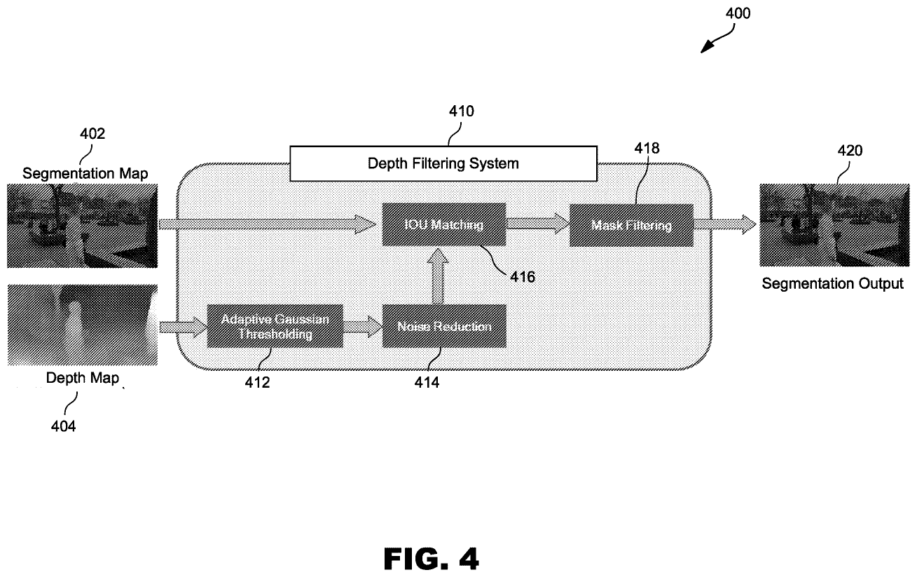

FIG. 4 is a diagram illustrating an example depth filtering process 400 for generating a segmentation output based on a segmentation map and estimated depth information. In some examples, the depth filtering process 400 can include, represent, or be the same as the depth filtering 308 shown in FIG. 3.

In this example, a depth filtering system 410 receives a segmentation map 402 and a depth map 404. In some examples, the depth filtering system 410 can be implemented by the image processing system 100. The segmentation map 402 and the depth map 404 can be based on an input frame, as previously explained. For example, the segmentation map 402 and the depth map 404 can be based on a monocular camera frame.

At block 412, the depth filtering system 410 can apply adaptive Gaussian thresholding to the depth map 404. In some examples, the adaptive Gaussian thresholding can help identify the target of interest in the depth map 404 based on the various depth values in the depth map 404. Moreover, the adaptive Gaussian thresholding can be used to select frame regions having depth values that differ from the depth values of surrounding/background pixels by a threshold amount. For example, in some cases, the adaptive Gaussian thresholding can identify one or more depth values of a target of interest in the depth map 404, and set a depth threshold or range used to subtract regions/pixels/objects in the depth map 404 that do not correspond to and/or are connected to the target of interest in the depth map 404. For example, the adaptive Gaussian thresholding can select/keep a target region(s) having a particular depth value(s), and exclude/subtract any pixels/regions in the depth map 404 that exceed the depth threshold or range and/or are not connected to the selected target region(s).

In some examples, the depth filtering system 410 can model the background of a scene (e.g., captured in the input frame) using any suitable background subtraction technique (also referred to as background extraction). For example, in some cases, the depth filtering system 410 can use a Gaussian distribution model for each pixel location, with parameters of mean and variance to model each pixel location in the depth map 404. In some examples, the values of previous pixels at a particular pixel location can be used to calculate the mean and variance of the target Gaussian model for the pixel location. When a pixel at a given location in an input frame is processed, its value can be evaluated by the current Gaussian distribution of this pixel location. A classification of the pixel as either a foreground pixel or a background pixel can be done by comparing the difference between the pixel value and the mean of the designated Gaussian model. In one illustrative example, if the distance of the pixel value and the Gaussian Mean is less than a certain amount of the variance, the pixel can be classified as a background pixel. Otherwise, in this illustrative example, the pixel can be classified as a foreground pixel.

At block 414, the depth filtering system 410) can perform noise reduction on the resulting depth map from the adaptive Gaussian thresholding. In some examples, the depth filtering system 410 can perform noise reduction via erosion and dilation operations. For example, in some cases, the depth filtering system 410) can perform morphology functions to filter the foreground pixels in the depth map 404. The morphology functions can include erosion and dilation functions. In one example, an erosion function can be applied, followed by a series of one or more dilation functions. An erosion function can be applied to remove pixels on target (e.g., object/region) boundaries.

For example, the depth filtering system 410 can apply an erosion function to a filter window of a center pixel that is being processed. The window can be applied to each foreground pixel (as the center pixel) in the foreground mask. The erosion function can include an erosion operation that sets a current foreground pixel in the foreground mask (acting as the center pixel) to a background pixel if one or more of its neighboring pixels within the window are background pixels. Such an erosion operation can be referred to as a strong erosion operation or a single-neighbor erosion operation. Here, the neighboring pixels of the current center pixel include the pixels in the window, with an additional pixel being the current center pixel.

A dilation operation can be used to enhance the boundary of a foreground object. For example, the depth filtering system 410 can apply a dilation function to a filter window of a center pixel. The dilation window can be applied to each background pixel (as the center pixel) in the foreground mask. The dilation function can include a dilation operation that sets a current background pixel in the foreground mask (acting as the center pixel) as a foreground pixel if one or more of its neighboring pixels in the window are foreground pixels. The neighboring pixels of the current center pixel include the pixels in the window, with an additional pixel being the current center pixel. In some examples, multiple dilation functions can be applied after an erosion function is applied. In one illustrative example, multiple function calls of dilation of a certain window size can be applied to the foreground mask. In some examples, an erosion function can be applied first to remove noise pixels, and a series of dilation functions can be applied to refine the foreground pixels. In one illustrative example, an erosion function with a certain window size is called first, and multiple function calls of dilation of a certain window size are applied to the foreground mask.

In some cases, after the morphology operations are performed, the depth filtering system 410 can apply a connected component analysis to connect neighboring foreground pixels to formulate connected components and blobs. In some implementations of a connected component analysis, one or more bounding boxes are returned in a way that each bounding box contains one component of connected pixels.

At block 416, the depth filtering system 410 can perform intersection-over-union (IOU) matching between the segmentation map 402 and the depth map 404 after the adaptive Gaussian thresholding and the noise reduction. The IOU matching can match salient depth regions in the depth map with predicted masks from the segmentation map 402 based on their IOU. In some examples, the IOU can measure the overlap between a depth mask (e.g., salient depth region) or bounding shape (e.g., bounding box, etc.) in the depth map and a segmentation mask or bounding shape in the segmentation map 402.

At block 418, the depth filtering system 410 can perform mask filtering based on the IOU matching. For example, the depth filtering system 410 can subtract/filter any masks (or bounding shapes) in the segmentation map 402 that have an IOU score below a threshold (e.g., that do not have sufficient overlap with a depth mask(s) in the depth map).

The depth filtering system 410 can then generate a segmentation output 420 which includes the segmentation map 402 without the masks (or bounding shapes) that have the IOU score below the threshold. The segmentation output 420 can provide higher segmentation accuracy/stability and prevent or minimize flickering in the sequence of frames associated with the input frame.

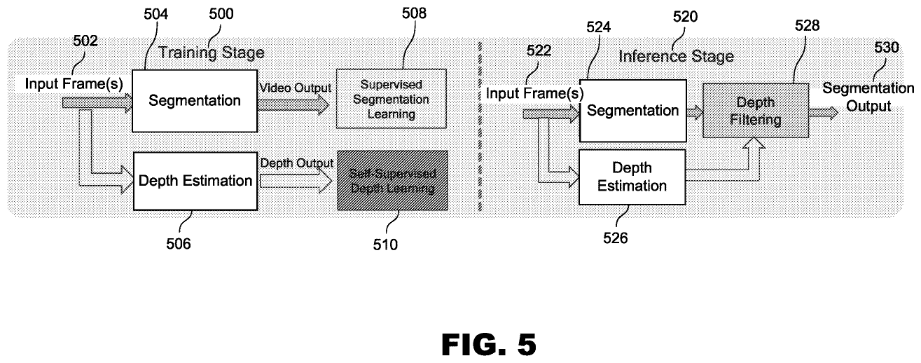

FIG. 5 is a diagram illustrating an example training stage 500 and an inference stage 520 for segmentation with depth filtering, in accordance with some examples of the present disclosure. In the training stage 500, the image processing system 100 can obtain an input frame 502 and perform segmentation 504 to generate a segmentation map. The image processing system 100 can also perform depth estimation 506 on the input frame 502 to generate a depth map. In some examples, the input frame can include a monocular camera frame, and the depth map can include monocular depth estimates.

The image processing system 100 can use the segmentation map from the segmentation 504 to perform supervised segmentation learning 508. In some examples, the image processing system 100 can implement a neural network (e.g., neural network 122) to perform the segmentation at the training stage 500 and the inference stage 520. In some cases, at the supervised segmentation learning 508 in the training stage 500, the image processing system 100 can use a training dataset to help calculate a loss for the output from the segmentation 504. The image processing system 100 can tune weights in the neural network based on the calculated loss to improve its segmentation results.

In some examples, the image processing system 100 can implement a neural network (e.g., neural network 122) to perform the depth estimation at the training stage 500 and the inference stage 520. In the training stage 500, the image processing system 100 can use the output from the depth estimation 506 to perform self-supervised depth learning 510. In some examples, the image processing system 100 can use a dataset of target outputs to generate a depth estimation model. In some cases, the image processing system 100 can use the depth estimation model to calculate depth estimates and/or determine depth estimation losses. In some examples, the image processing system 100 can calculate depth estimates and determine if they match the associated frame. The image processing system 100 can then tune weights of the neural network based on the matching results and/or calculated losses.

At the inference stage 520, the image processing system 100 can perform the process 300 and the depth filtering process 400 as previously described with respect to FIG. 3 and FIG. 4. For example, the image processing system 100 can perform semantic segmentation 524 on an input frame 522 to generate a segmentation map. The image processing system 100 can also perform depth estimation 526 on the input frame 522 to generate a depth map.

The image processing system 100 can then use the segmentation map and the depth map to perform depth filtering 528. The depth filtering 528 can compare the segmentation map and the depth map to subtract regions/pixels that do not have a threshold amount of overlap between the segmentation map and the depth map. For example, as previously explained, the image processing system 100 can calculate IOU scores between the segmentation map and the depth map, and subtract pixels/regions with IOU scores below a threshold. The image processing system 100 can generate a segmentation output 530) (e.g., a filtered segmentation map) based on the depth filtering 528. The segmentation output 530) can provide higher segmentation accuracy/stability and prevent or minimize flickering in a sequence of frames associated with the input frame 522.

As illustrated, the image processing system 100 can use three-dimensional (3D) depth prediction of a current frame to filter out objects that are part of the background, unwanted, remote, small, and/or a combination thereof. The segmentation with depth filtering described herein can produce reliable temporal consistency of the segmentation frames.

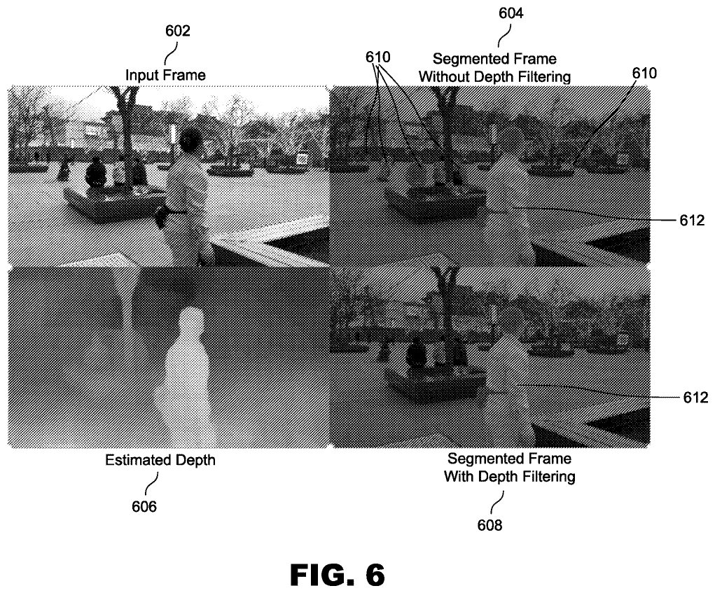

FIG. 6 is a diagram illustrating examples of segmented frames without depth filtering and with depth filtering. Here, an input frame 602 is used to generate a segmented frame 604 that does not include depth filtering. As shown, the segmented frame 604 has detected (e.g., segmented, masked, identified) the target of interest 612 in the foreground, but has also detected various subjects 610 in the background, which are not of interest. In a sequence of frames including the segmented frame 604, the detected subjects 610 can cause flickering as they are detected in the segmented frame 604 and not detected in other frames of the sequence of frames.

On the other hand, FIG. 6 also shows a segmented frame 608 with depth filtering as described herein. The segmented frame 608 is generated based on estimated depths 606 calculated for the input frame 602 and a segmentation map calculated for the input frame. As shown, the segmented frame 608 successfully detected the target of interest 612 without also detecting the subjects 610, as the subjects 610 have been filtered out using the estimated depths 606. As a result, the segmented frame 608 will not cause flickering from the subjects 610 being detected in some frames and not others.

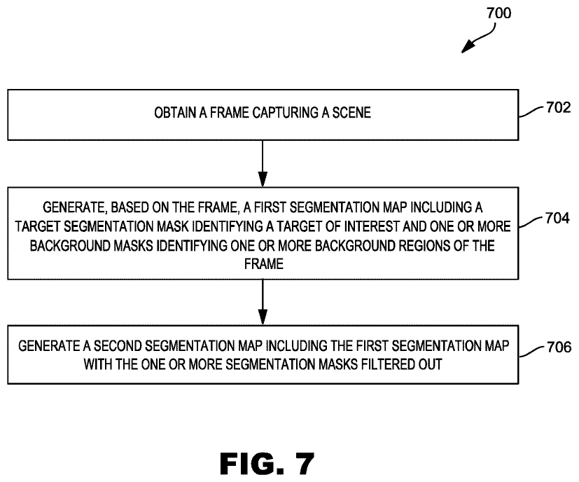

FIG. 7 is a flowchart of an example of a process 700 for semantic segmentation with depth filtering, in accordance with some examples of the present disclosure. At block 702, the process 700 can include obtaining a frame capturing a scene. The frame can include one or more foreground regions and one or more background regions. In some examples, the frame is a monocular frame captured by a monocular camera device (e.g., image capture device 102).

At block 704, the process 700 can include generating, based on the frame, a first segmentation map (e.g., segmentation map 304, segmentation map 402) including a target segmentation mask identifying a target of interest (e.g., person 202 or target of interest 612) and one or more background masks identifying one or more background regions of the frame (e.g., objects 210 or subjects 610).

At block 706, the process 700 can include generating a second segmentation map (e.g., segmentation result 310, segmentation output 420) including the first segmentation map with the one or more background masks filtered out. In some examples, the one or more background masks can be filtered from the first segmentation map based on a depth map (e.g., depth estimates 306, depth map 404) associated with the frame.

In some aspects, the process 700 can include generating, based on the frame, the depth map (e.g., depth estimates 306, depth map 404), the depth map including depth values associated with pixels of the frame.

In some aspects, the process 700 can include filtering the one or more background masks from the first segmentation map based on the depth values in the depth map. In some examples, generating the second segmentation map can include determining, based on a comparison of the first segmentation map with the depth map, a threshold difference between respective depth values associated with the one or more background masks and respective depth values associated with the target segmentation mask identifying the target of interest. In some aspects, the process 700 can include, based on the threshold difference between respective depth values associated with the one or more background masks and respective depth values associated with the target segmentation mask identifying the target of interest, removing the one or more background masks from the first segmentation map.

In some cases, the depth map includes a set of depth masks associated with depth values corresponding to pixels of the frame. In some examples, generating the second segmentation map can include determining, based on a comparison of the first segmentation map with the depth map, an overlap between the target segmentation mask identifying the target of interest and one or more depth masks from the set of depth masks in the depth map: based on the overlap, keeping the target segmentation mask identifying the target of interest; and based on an additional overlap between the one or more background masks and one or more additional depth masks from the set of depth masks, filtering the one or more background masks from the first segmentation map.

In some examples, generating the second segmentation map can further include determining that a difference between depth values associated with the one or more additional depth masks and depth values associated with the one or more depth masks exceeds a threshold; and based on the difference exceeding the threshold, filtering the one or more background masks from the first segmentation map. In some cases, the one or more depth masks correspond to the target of interest and the one or more additional depth masks correspond to the one or more background regions of the frame.

In some cases, generating the second segmentation map can include determining intersection-over-union (IOU) scores associated with depth regions from the depth map and predicted masks from the first segmentation map: based on the IOU scores, matching the depth regions from the depth map with the predicted masks from the first segmentation map, the predicted masks including the target segmentation mask identifying the target of interest and the one or more background masks identifying the one or more background regions of the frame; and filtering the one or more background masks from the first segmentation map based on a determination that one or more IOU scores associated with the one or more background masks are below a threshold.

In some aspects, the process 700 can include generating, based on the frame and the second segmentation map, a modified frame. In some examples, the modified frame can include at least one of a visual effect, an extended reality effect, an image processing effect, a blurring effect, an image recognition effect, an object detection effect, a computer graphics effect, a chroma keying effect, and an image stylization effect.

In some aspects, the process 700 can include, prior to filtering the one or more background masks from the first segmentation map, applying adaptive Gaussian thresholding and noise reduction to the depth map.

In some examples, the first segmentation map and the second segmentation map are generated using one or more neural networks. In some examples, the depth map is generated using a neural network.

In some examples, the process 300, 400, and/or 700 may be performed by one or more computing devices or apparatuses. In one illustrative example, the process 300, 400, and/or 700 can be performed by the image processing system 100 shown in FIG. 1 and/or one or more computing devices with the computing device architecture 800 shown in FIG. 8. In some cases, such a computing device or apparatus may include a processor, microprocessor, microcomputer, or other component of a device that is configured to carry out the steps of the process 300, 400, and/or 700. In some examples, such computing device or apparatus may include one or more sensors configured to capture image data. For example, the computing device can include a smartphone, a head-mounted display, a mobile device, a camera, a tablet computer, or other suitable device. In some examples, such computing device or apparatus may include a camera configured to capture one or more images or videos. In some cases, such computing device may include a display for displaying images. In some examples, the one or more sensors and/or camera are separate from the computing device, in which case the computing device receives the sensed data. Such computing device may further include a network interface configured to communicate data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The processes 300, 400, and 700 are illustrated as logical flow diagrams, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 300, 400, and/or 700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 illustrates an example computing device architecture 800 of an example computing device which can implement various techniques described herein. For example, the computing device architecture 800 can implement at least some portions of the image processing system 100 shown in FIG. 1. The components of the computing device architecture 800 are shown in electrical communication with each other using a connection 805, such as a bus. The example computing device architecture 800 includes a processing unit (CPU or processor) 810 and a computing device connection 805 that couples various computing device components including the computing device memory 815, such as read only memory (ROM) 820) and random access memory (RAM) 825, to the processor 810.

The computing device architecture 800 can include a cache of high-speed memory connected directly with, in close proximity to, or integrated as part of the processor 810. The computing device architecture 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other computing device memory 815 may be available for use as well. The memory 815 can include multiple different types of memory with different performance characteristics.

The processor 810 can include any general purpose processor and a hardware or software service, such as service 1 832, service 2 834, and service 3 836 stored in storage device 830, configured to control the processor 810 as well as a special-purpose processor where software instructions are incorporated into the processor design. The processor 810 may be a self-contained system, containing multiple cores or processors, a bus, memory controller, cache, etc. A multi-core processor may be symmetric or asymmetric.

To enable user interaction with the computing device architecture 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art, such as a display, projector, television, speaker device. In some instances, multimodal computing devices can enable a user to provide multiple types of input to communicate with the computing device architecture 800. The communication interface 840) can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 185, read only memory (ROM) 820, and hybrids thereof. The storage device 830 can include services 832, 834, 836 for controlling the processor 810. Other hardware or software modules are contemplated. The storage device 830 can be connected to the computing device connection 805. In one aspect, a hardware module that performs a particular function can include the software component stored in a computer-readable medium in connection with the necessary hardware components, such as the processor 810, connection 805, output device 835, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic array's (FPGAs), or other equivalent integrated or discrete logic circuitry. Such a processor may be configured to perform any of the techniques described in this disclosure. A general purpose processor may be a microprocessor: but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for image segmentation, the apparatus comprising: memory; and one or more processors coupled to the memory, the one or more processors being configured to: obtain a frame capturing a scene: generate, based on the frame, a first segmentation map comprising a target segmentation mask identifying a target of interest and one or more background masks identifying one or more background regions of the frame; and generate a second segmentation map comprising the first segmentation map with the one or more background masks filtered out, the one or more background masks being filtered from the first segmentation map based on a depth map associated with the frame.

Aspect 2. The apparatus of Aspect 1, wherein, to generate the second segmentation map, the one or more processors are configured to: based on a comparison of the first segmentation map with the depth map, determine a threshold difference between respective depth values associated with the one or more background masks and respective depth values associated with the target segmentation mask identifying the target of interest.

Aspect 3. The apparatus of Aspect 2, wherein, to generate the second segmentation map, the one or more processors are configured to: based on the threshold difference between respective depth values associated with the one or more background masks and respective depth values associated with the target segmentation mask identifying the target of interest, remove the one or more background masks from the first segmentation map.

Aspect 4. The apparatus of any of Aspects 1 to 3, wherein the depth map comprises a set of depth masks associated with depth values corresponding to pixels of the frame, and wherein, to generate the second segmentation map, the one or more processors are configured to: based on a comparison of the first segmentation map with the depth map, determine an overlap between the target segmentation mask identifying the target of interest and one or more depth masks from the set of depth masks in the depth map: based on the overlap, keep the target segmentation mask identifying the target of interest; and based on an additional overlap between the one or more background masks and one or more additional depth masks from the set of depth masks, filter the one or more background masks from the first segmentation map.

Aspect 5. The apparatus of Aspect 4, wherein, to generate the second segmentation map, the one or more processors are configured to: determine that a difference between depth values associated with the one or more additional depth masks and depth values associated with the one or more depth masks exceeds a threshold; and based on the difference exceeding the threshold, filter the one or more background masks from the first segmentation map, wherein the one or more depth masks correspond to the target of interest and the one or more additional depth masks correspond to the one or more background regions of the frame.

Aspect 6. The apparatus of any of Aspects 1 to 5, wherein, to generate the second segmentation map, the one or more processors are configured to: determine intersection-over-union (IOU) scores associated with depth regions from the depth map and predicted masks from the first segmentation map: based on the IOU scores, match the depth regions from the depth map with the predicted masks from the first segmentation map, the predicted masks comprising the target segmentation mask identifying the target of interest and the one or more background masks identifying the one or more background regions of the frame; and filter the one or more background masks from the first segmentation map based on a determination that one or more IOU scores associated with the one or more background masks are below a threshold.

Aspect 7. The apparatus of Aspect 6, wherein the one or more processors are configured to: prior to filtering the one or more background masks from the first segmentation map, apply adaptive Gaussian thresholding and noise reduction to the depth map.

Aspect 8. The apparatus of any of Aspects 1 to 7, wherein the frame comprises a monocular frame generated by a monocular image capture device.

Aspect 9. The apparatus of any of Aspects 1 to 8, wherein the first segmentation map and the second segmentation map are generated using one or more neural networks.

Aspect 10. The apparatus of any of Aspects 1 to 9, wherein the one or more processors are configured to generate the depth map using a neural network.

Aspect 11. The apparatus of any of Aspects 1 to 10, wherein the one or more processors are configured to: generate, based on the frame and the second segmentation map, a modified frame.

Aspect 12. The apparatus of Aspect 11, wherein the modified frame includes at least one of a visual effect, an extended reality effect, an image processing effect, a blurring effect, an image recognition effect, an object detection effect, a computer graphics effect, a chroma keying effect, and an image stylization effect.

Aspect 13. The apparatus of any of Aspects 1 to 12, further comprising an image capture device, wherein the frame is generated by the image capture device.

Aspect 14. The apparatus of any of Aspects 1 to 13, wherein the apparatus comprises a mobile device.

Aspect 15. A method for image segmentation, the method comprising: obtaining a frame capturing a scene: generating, based on the frame, a first segmentation map comprising a target segmentation mask identifying a target of interest and one or more background masks identifying one or more background regions of the frame; and generating a second segmentation map comprising the first segmentation map with the one or more background masks filtered out, the one or more background masks being filtered from the first segmentation map based on a depth map associated with the frame.

Aspect 16. The method of Aspect 15, wherein generating the second segmentation map comprises: based on a comparison of the first segmentation map with the depth map, determining a threshold difference between respective depth values associated with the one or more background masks and respective depth values associated with the target segmentation mask identifying the target of interest.

Aspect 17. The method of Aspect 16, wherein generating the second segmentation map further comprises: based on the threshold difference between respective depth values associated with the one or more background masks and respective depth values associated with the target segmentation mask identifying the target of interest, removing the one or more background masks from the first segmentation map.

Aspect 18. The method of any of Aspects 15 to 17, wherein the depth map comprises a set of depth masks associated with depth values corresponding to pixels of the frame, and wherein generating the second segmentation map comprises: based on a comparison of the first segmentation map with the depth map, determining an overlap between the target segmentation mask identifying the target of interest and one or more depth masks from the set of depth masks in the depth map: based on the overlap, keeping the target segmentation mask identifying the target of interest; and based on an additional overlap between the one or more background masks and one or more additional depth masks from the set of depth masks, filtering the one or more background masks from the first segmentation map.

Aspect 19. The method of Aspect 18, wherein generating the second segmentation map further comprises: determining that a difference between depth values associated with the one or more additional depth masks and depth values associated with the one or more depth masks exceeds a threshold; and based on the difference exceeding the threshold, filtering the one or more background masks from the first segmentation map, wherein the one or more depth masks correspond to the target of interest and the one or more additional depth masks correspond to the one or more background regions of the frame.

Aspect 20. The method of any of Aspects 15 to 19, wherein generating the second segmentation map comprises: determining intersection-over-union (IOU) scores associated with depth regions from the depth map and predicted masks from the first segmentation map; based on the IOU scores, matching the depth regions from the depth map with the predicted masks from the first segmentation map, the predicted masks comprising the target segmentation mask identifying the target of interest and the one or more background masks identifying the one or more background regions of the frame; and filtering the one or more background masks from the first segmentation map based on a determination that one or more IOU scores associated with the one or more background masks are below a threshold.

Aspect 21. The method of Aspect 20, wherein the one or more processors are configured to: prior to filtering the one or more background masks from the first segmentation map, applying adaptive Gaussian thresholding and noise reduction to the depth map.

Aspect 22. The method of any of Aspects 15 to 21, wherein the frame comprises a monocular frame generated by a monocular image capture device.

Aspect 23. The method of any of Aspects 15 to 22, wherein the first segmentation map and the second segmentation map are generated using one or more neural networks.

Aspect 24. The method of any of Aspects 15 to 23, further comprising generating the depth map using a neural network.

Aspect 25. The method of any of Aspects 15 to 24, further comprising: generating, based on the frame and the second segmentation map, a modified frame.

Aspect 26. The method of Aspect 25, wherein the modified frame includes at least one of a visual effect, an extended reality effect, an image processing effect, a blurring effect, an image recognition effect, an object detection effect, a computer graphics effect, a chroma keying effect, and an image stylization effect.

Aspect 27. A non-transitory computer-readable medium having stored thereon instructions that, when executed by one or more processors, cause the one or more processors to perform a method according to any of Aspects 15 to 26.

Aspect 28. An apparatus comprising means for performing a method according to any of Aspects 15 to 26.

What is claimed is:

1. An apparatus for image segmentation, the apparatus comprising:
memory; and
one or more processors coupled to the memory, the one or more processors being configured to:
obtain a frame capturing a scene:
generate, based on the frame, a first segmentation map comprising a target segmentation mask identifying a target of interest and one or more background masks identifying one or more background regions of the frame; and
generate a second segmentation map comprising the first segmentation map with the one or more background masks filtered out, the one or more background masks being filtered from the first segmentation map based on a depth map associated with the frame.

2. The apparatus of claim 1, wherein, to generate the second segmentation map, the one or more processors are configured to:
based on a comparison of the first segmentation map with the depth map, determine a threshold difference between respective depth values associated with the one or more background masks and respective depth values associated with the target segmentation mask identifying the target of interest.

3. The apparatus of claim 2, wherein, to generate the second segmentation map, the one or more processors are configured to:
based on the threshold difference between respective depth values associated with the one or more background masks and respective depth values associated with the target segmentation mask identifying the target of interest, remove the one or more background masks from the first segmentation map.

4. The apparatus of claim 1, wherein the depth map comprises a set of depth masks associated with depth values corresponding to pixels of the frame, and wherein, to generate the second segmentation map, the one or more processors are configured to:
based on a comparison of the first segmentation map with the depth map, determine an overlap between the target segmentation mask identifying the target of interest and one or more depth masks from the set of depth masks in the depth map:
based on the overlap, keep the target segmentation mask identifying the target of interest; and
based on an additional overlap between the one or more background masks and one or more additional depth masks from the set of depth masks, filter the one or more background masks from the first segmentation map.

5. The apparatus of claim 4, wherein, to generate the second segmentation map, the one or more processors are configured to:
determine that a difference between depth values associated with the one or more additional depth masks and depth values associated with the one or more depth masks exceeds a threshold; and
based on the difference exceeding the threshold, filter the one or more background masks from the first segmentation map, wherein the one or more depth masks correspond to the target of interest and the one or more additional depth masks correspond to the one or more background regions of the frame.

6. The apparatus of claim 1, wherein, to generate the second segmentation map, the one or more processors are configured to:
determine intersection-over-union (IOU) scores associated with depth regions from the depth map and predicted masks from the first segmentation map:
based on the IOU scores, match the depth regions from the depth map with the predicted masks from the first segmentation map, the predicted masks comprising the target segmentation mask identifying the target of interest and the one or more background masks identifying the one or more background regions of the frame; and
filter the one or more background masks from the first segmentation map based on a determination that one or more IOU scores associated with the one or more background masks are below a threshold.

7. The apparatus of claim 6, wherein the one or more processors are configured to:
prior to filtering the one or more background masks from the first segmentation map, apply adaptive Gaussian thresholding and noise reduction to the depth map.

8. The apparatus of claim 1, wherein the frame comprises a monocular frame generated by a monocular image capture device.

9. The apparatus of claim 1, wherein the first segmentation map and the second segmentation map are generated using one or more neural networks.

10. The apparatus of claim 1, wherein the one or more processors are configured to generate the depth map using a neural network.

11. The apparatus of claim 1, wherein the one or more processors are configured to:
generate, based on the frame and the second segmentation map, a modified frame.

12. The apparatus of claim 11, wherein the modified frame includes at least one of a visual effect, an extended reality effect, an image processing effect, a blurring effect, an image recognition effect, an object detection effect, a computer graphics effect, a chroma keying effect, and an image stylization effect.

13. The apparatus of claim 1, further comprising an image capture device, wherein the frame is generated by the image capture device.

14. The apparatus of claim 1, wherein the apparatus comprises a mobile device.

15. A method for image segmentation, the method comprising:
obtaining a frame capturing a scene:
generating, based on the frame, a first segmentation map comprising a target segmentation mask identifying a target of interest and one or more background masks identifying one or more background regions of the frame; and
generating a second segmentation map comprising the first segmentation map with the one or more background masks filtered out, the one or more background masks being filtered from the first segmentation map based on a depth map associated with the frame.

16. The method of claim 15, wherein generating the second segmentation map comprises:
based on a comparison of the first segmentation map with the depth map, determining a threshold difference between respective depth values associated with the one or more background masks and respective depth values associated with the target segmentation mask identifying the target of interest.

17. The method of claim 16, wherein generating the second segmentation map further comprises:
based on the threshold difference between respective depth values associated with the one or more background masks and respective depth values associated with the target segmentation mask identifying the target of interest, removing the one or more background masks from the first segmentation map.

18. The method of claim 15, wherein the depth map comprises a set of depth masks associated with depth values corresponding to pixels of the frame, and wherein generating the second segmentation map comprises:
based on a comparison of the first segmentation map with the depth map, determining an overlap between the target segmentation mask identifying the target of interest and one or more depth masks from the set of depth masks in the depth map:
based on the overlap, keeping the target segmentation mask identifying the target of interest; and
based on an additional overlap between the one or more background masks and one or more additional depth masks from the set of depth masks, filtering the one or more background masks from the first segmentation map.

19. The method of claim 18, wherein generating the second segmentation map further comprises:
determining that a difference between depth values associated with the one or more additional depth masks and depth values associated with the one or more depth masks exceeds a threshold; and
based on the difference exceeding the threshold, filtering the one or more background masks from the first segmentation map, wherein the one or more depth masks correspond to the target of interest and the one or more additional depth masks correspond to the one or more background regions of the frame.

20. The method of claim 15, wherein generating the second segmentation map comprises:
determining intersection-over-union (IOU) scores associated with depth regions from the depth map and predicted masks from the first segmentation map:
based on the IOU scores, matching the depth regions from the depth map with the predicted masks from the first segmentation map, the predicted masks comprising the target segmentation mask identifying the target of interest and the one or more background masks identifying the one or more background regions of the frame; and
filtering the one or more background masks from the first segmentation map based on a determination that one or more IOU scores associated with the one or more background masks are below a threshold.

21. The method of claim 20, further comprising:
prior to filtering the one or more background masks from the first segmentation map, applying adaptive Gaussian thresholding and noise reduction to the depth map.

22. The method of claim 15, wherein the frame comprises a monocular frame generated by a monocular image capture device.

23. The method of claim 15, wherein the first segmentation map and the second segmentation map are generated using one or more neural networks.

24. The method of claim 15, further comprising generating the depth map using a neural network.

25. The method of claim 15, further comprising:
generating, based on the frame and the second segmentation map, a modified frame.

26. The method of claim 25, wherein the modified frame includes at least one of a visual effect, an extended reality effect, an image processing effect, a blurring effect, an image recognition effect, an object detection effect, a computer graphics effect, a chroma keying effect, and an image stylization effect.

27. A non-transitory computer-readable medium having stored thereon instructions that, when executed by one or more processors, cause the one or more processors to:
obtain a frame capturing a scene:
generate, based on the frame, a first segmentation map comprising a target segmentation mask identifying a target of interest and one or more background masks identifying one or more background regions of the frame; and
generate a second segmentation map comprising the first segmentation map with the one or more background masks filtered out, the one or more background masks being filtered from the first segmentation map based on a depth map associated with the frame.

28. The non-transitory computer-readable medium of claim 27, wherein generating the second segmentation map comprises:
based on a comparison of the first segmentation map with the depth map, determining a threshold difference between respective depth values associated with the one or more background masks and respective depth values associated with the target segmentation mask identifying the target of interest.

29. The non-transitory computer-readable medium of claim 28, wherein generating the second segmentation map further comprises:
based on the threshold difference between respective depth values associated with the one or more background masks and respective depth values associated with the target segmentation mask identifying the target of interest, removing the one or more background masks from the first segmentation map.
